(19) United States
(12) Patent Application Publication
(10) Pub. No.: US 2014/0238525 A1
(43) Pub. Date: Aug. 28, 2014

(54) THERMOPLASTIC COMPOSITE PIPE WITH LONGITUDINAL REINFORCEMENT

(71) Applicant: THERCOM HOLDINGS, LLC, Bloomfield Hills, MI (US)

(72) Inventor: Joel A. Dyksterhouse, Cross Village, MI (US)

(73) Assignee: THERCOM HOLDINGS, LLC, Bloomfield Hills, MI (US)

(21) Appl. No.: 13/773,796

(22) Filed: Feb. 22, 2013

(51) Int. Cl. F16L 9/04

(52) U.S. Cl. CPC F16L 9/04
USPC 138/153; 29/428; 156/172

(57) ABSTRACT

A reinforced pipe includes a pipe liner, longitudinal reinforcement, and a helically wound radial reinforcement layer. The longitudinal reinforcement includes a unidirectional material generally parallel to the axis of the pipe liner. The longitudinal reinforcement prevents the pipe from expanding lengthwise, and the radial reinforcement layer prevents the pipe from expanding radially.

### BACKGROUND OF THE INVENTION

The present invention relates to reinforced pipe, and more specifically to thermoplastic composite reinforced pipe.

Thermoplastic composite (TPC) pipe constructions are known and recognized for their strength. Therefore TPC pipe is used in a variety of applications for conveying fluids, especially at relatively high pressures. Typically, TPC pipe includes a thermoplastic liner, a TPC overwrap helically wrapped around the liner, and a thermoplastic jacket over the overwrap. Preferably, all of these layers are thoroughly bonded to one another.

TPC pipe can be pressure rated up to tens of thousands of pounds per square inch (PSI). Once rated at a specific pressure, it is important that a TPC pipe actually perform to the rating. Failures to do so can have consequences ranging from relatively small leaks to catastrophic failures. Every level of failure, even a relatively small leak, is unacceptable in some application. Consequently, a continuing need exists to identify actual and potential failures, to identify the causes of the failures, and to develop techniques to prevent future similar failures.

### SUMMARY OF THE INVENTION

The present invention includes both the identification of a cause of failure and a number of techniques to prevent future similar failures.

The identification of a cause of failure is described as follows. Under high internal pressures, the fluid pushes radially outwardly on the pipe; and the tendency of the TPC pipe is to expand circumferentially. However, because the TPC overwrap does not expand, the thermoplastic liner tends to lengthen. This lengthening of the liner pulls on the overwrap that is bonded to the liner, and consequently the lengthening can cause tearing or separation within the overwrap, possibly creating weak points and causing premature failure. Even relatively small tears or separations can have completely unacceptable consequences.

The present invention includes a number of techniques for preventing future failures.

In one aspect, the TPC pipe includes a thermoplastic pipe liner having a longitudinal axis, a TPC overwrap, and an intermediate layer between the liner and the overwrap. The intermediate layer includes fibers oriented generally parallel to the axis of the liner.

In another aspect, the TPC pipe includes a thermoplastic liner having a longitudinal axis and a TPC overwrap. The liner includes fibers within or on the liner. The fibers are generally parallel to the axis of the liner.

In yet another aspect, a method for forming a TPC pipe includes providing a liner having an axis, applying fibers on or within the pipe liner with the fibers generally parallel to the axis, and applying a TPC overwrap over the liner and fibers.

In each aspect, the axially oriented fibers resist, and in some cases prevent, lengthening of the liner when the pipe is under pressure. The reduced or prevented liner lengthening reduces or eliminates tearing and separation within the overwrap. And consequently, the axially oriented fibers reduce or eliminate failures. Pipes in accordance with the present invention therefore have improved performance and reliability over pipes known in the art.

These and other features and advantages of the invention will be more fully understood and appreciated by reference to the entire application including the specification, the claims, and the drawings.

### BRIEF DESCRIPTION OF THE DRAWINGS

FIG. 1 is a perspective cutaway view of a reinforced pipe in accordance with a first embodiment of the present invention;

FIG. 2 is a cross-sectional view of the reinforced pipe, taken along line II-II of FIG. 1;

FIG. 3 is a perspective cutaway view of a reinforced pipe in accordance with a second embodiment;

FIG. 4 is a cross-sectional view of the second embodiment, taken along line IV-IV of FIG. 3;

FIG. 5 is a perspective cutaway view of a reinforced pipe in accordance with a third embodiment;

FIG. 6 is a cross-sectional view of the third embodiment, taken along line VI-VI of FIG. 5;

FIG. 7 is a perspective cutaway view of a reinforced pipe in accordance with a fourth embodiment;

FIG. 8 is a cross-sectional view of the fourth embodiment, taken along line VIII-VIII of FIG. 7;

FIG. 9 is a flowchart of a first method for forming a reinforced pipe;

FIG. 10 is a flowchart of a second method for forming a reinforced pipe.

### DESCRIPTION OF THE CURRENT EMBODIMENTS

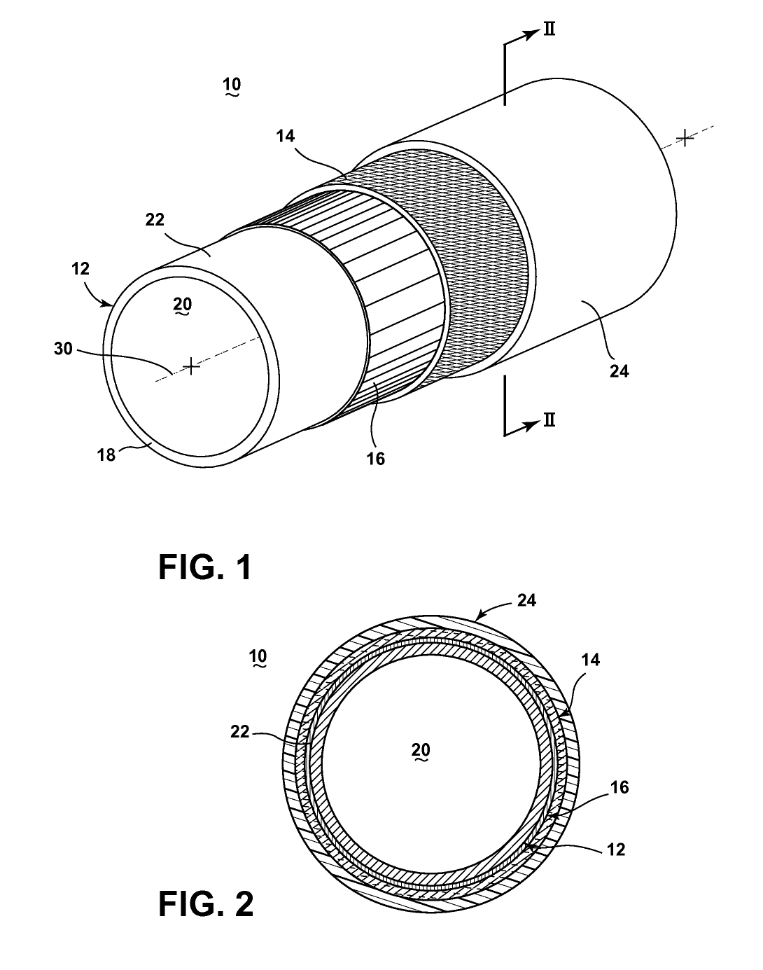

The invention as contemplated and disclosed herein includes a reinforced pipe and a related method of manufacture. With reference to FIGS. 1 and 2, a reinforced pipe in accordance with one embodiment is illustrated and generally designated with reference numeral 10. The reinforced pipe includes a liner or inner tubular member 12, an overwrap or reinforcing layer 14, and an intermediate layer 16 between the liner 12 and the overwrap 14.

More particularly, the inner tubular member 12 preferably is a thermoplastic extrusion, for example, of a high density polyethylene (HDPE). The inner tubular member 12 includes a sidewall 18 defining an inner surface 20 and an outer surface 22. The outer surface 22 is spaced apart from the inner surface 20 by a desired sidewall thickness. The inner surface 20 defines a conduit for a moving fluid, for example an aqueous fluid, a gaseous fluid, and combinations thereof.

The reinforced pipe 10 includes a reinforcing layer 14. The reinforcing layer 14 includes an inner surface facing the outer surface 22 of the tubular member 12. The reinforcing layer 14 can include any material adapted to increase the burst strength of the tubular member 12. In the present embodiment, the reinforcing layer 14 preferably is a TPC tape helically wound about the exterior of the tubular member 12 and the intermediate layer 16. The thermoplastic composite tape can include directional fibers and/or woven fibers. The fibers may include for example carbon, aramid, fiberglass, aluminum or titanium. The reinforcing fibers may be disposed in a thermoplastic matrix material, for example polyamide, polyethylene terephtalate (PET), polyphenylene sulphide (PPS), polybutylene terephthalate (PBT), polysulfone, or polycarbonate.

Additional layers can also be included in the reinforced pipe 10. As shown in FIG. 1 for example, an exterior layer or jacket 24 can be added to the exterior of the reinforcing layer 14. The jacket 24 can be fused to the reinforcing layer 14, which may be fused to the tubular member 12 to form a multi-layer TPC pipe for high pressure applications.

In a first embodiment, illustrated in FIGS. 1 and 2, the intermediate layer or longitudinal reinforcement 16, is between the tubular member 12 and the reinforcing layer 14. The intermediate layer 16 is defined by strips which are parallel to a longitudinal axis 30 of the tubular member 12. As illustrated, the layer 16 is continuous circumferentially, encircling the entire tubular member 12. Further, the intermediate layer 16 can be thermally bonded to the tubular member 12, and the reinforcing layer 14 can be thermally bonded to the intermediate layer 16. As illustrated, the layer 16 is on the exterior of the liner 12. Alternatively, the layer may be on the interior of the liner 12.

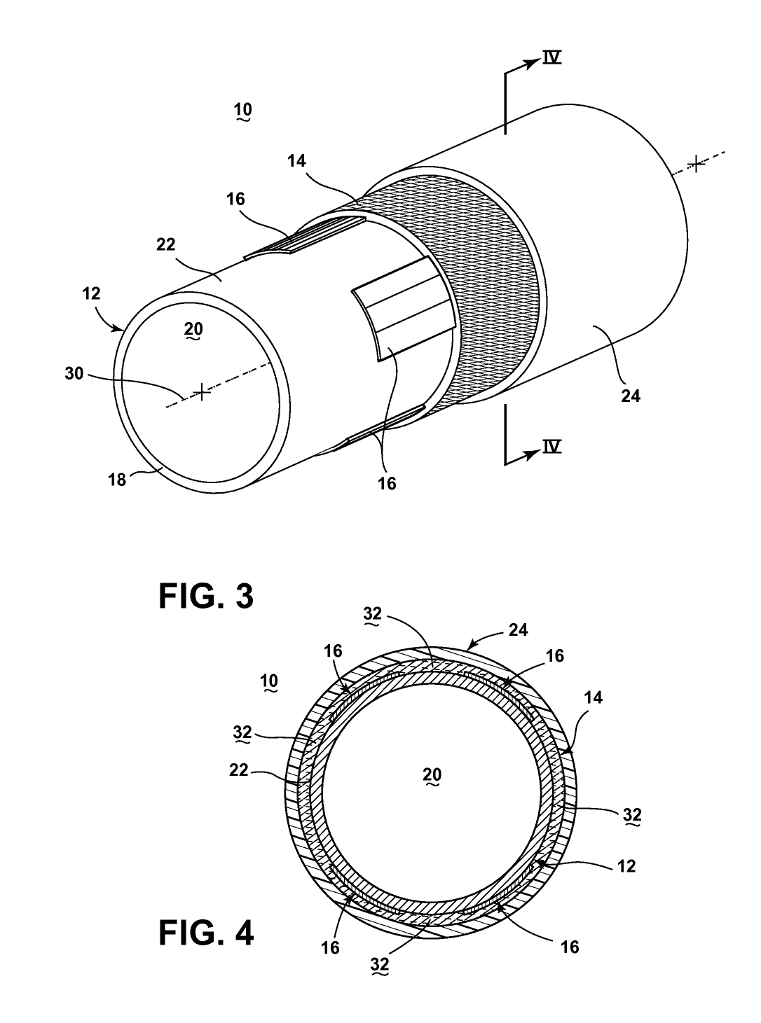

Referring now to FIGS. 3 and 4, in a second embodiment, the intermediate layer 16 is again defined by strips which are generally parallel to the longitudinal axis 30 of the tubular member 12. However, unlike the first embodiment, the strips are positioned at intervals around the circumference of the pipe liner, defining spaces 32 between the strips of the intermediate layer 16. The strips and spaces 32 may be arranged in any suitable repeating pattern, regular or irregular. As illustrated in FIG. 3, the intermediate layer 16 may include three strips. Other patterns, be they repeating or random, are within the scope of the invention. The intermediate layer 16 may be thermally bonded to the tubular member 12, and the reinforcing layer 14 may be thermally bonded to both the intermediate layer 16 and the tubular member 12 where it is exposed in the spaces 32. References to bonding in this application assume similar chemical affinity or polarity.

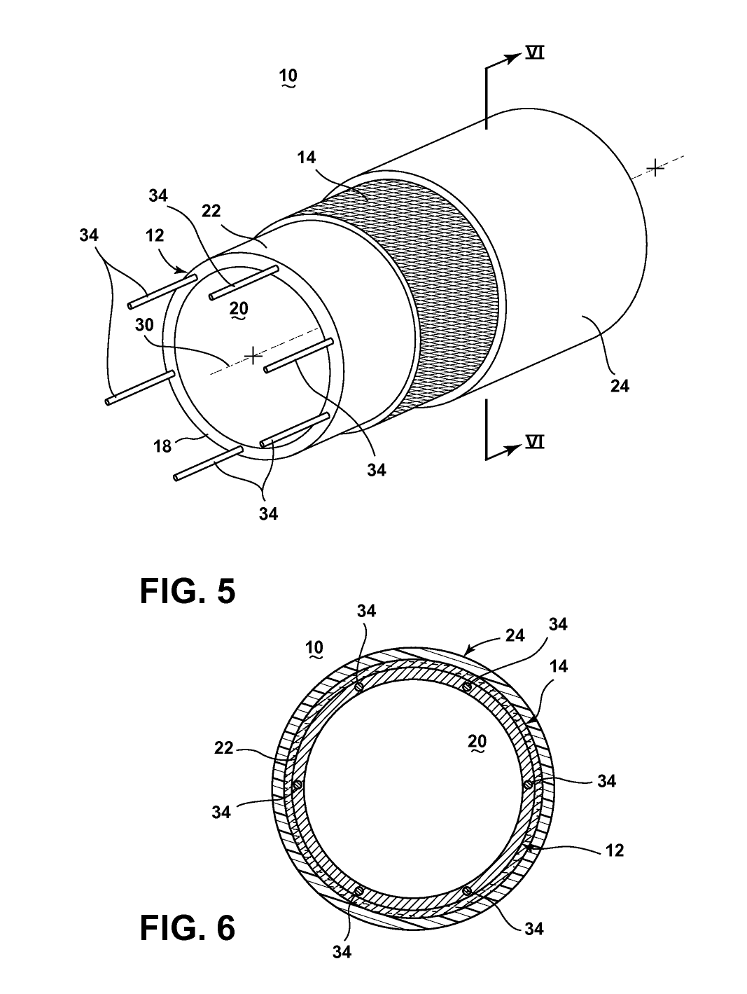

A third embodiment of the pipe is illustrated in FIGS. 5 and 6. In this embodiment, the longitudinal fibers 16 are within the extruded tubular member 12. The intermediate layer is a plurality of unidirectional fiber elements 34 which are oriented parallel to the longitudinal axis 30 of the tubular member 12. The elements may be circular or virtually any other shape in cross section. The elements 34 may be placed in the tubular member 12 during the extrusion process. The elements 34 are positioned at intervals around the circumference of the tubular member 12. The intervals may be regular or irregular, and also may be spaced or overlapping.

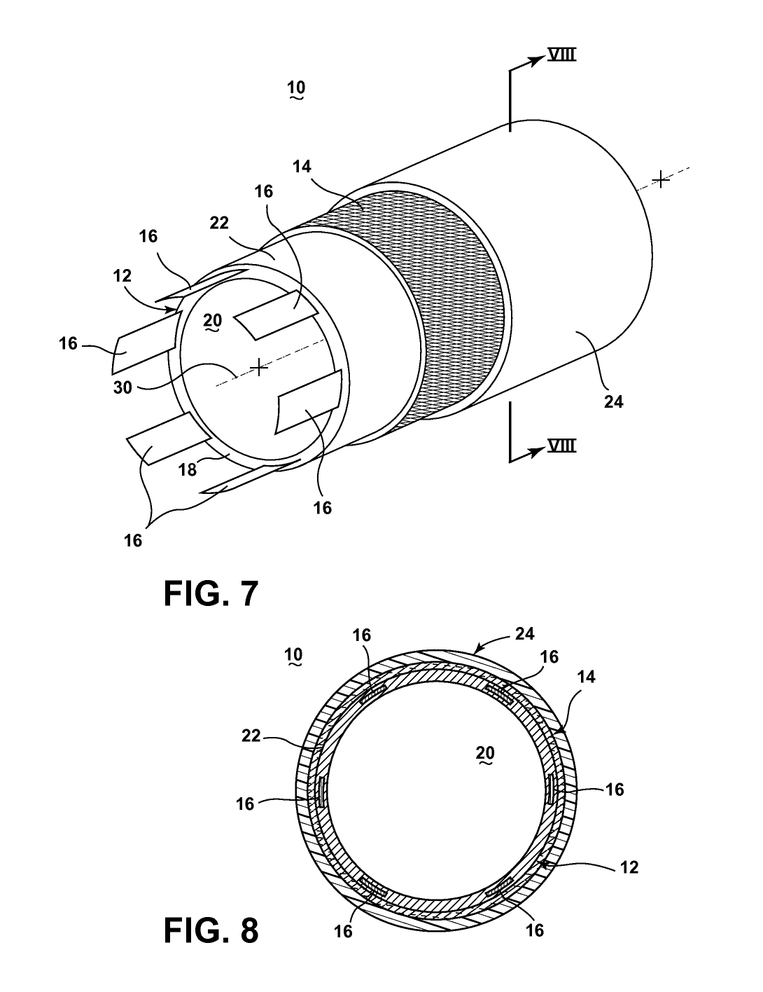

A fourth embodiment of the pipe is illustrated in FIGS. 7 and 8. The intermediate layer 16 is again defined by strips parallel to the longitudinal axis 30 of the tubular member 12. However, the strips are within the extruded tubular member 12. The strips may be placed in the tubular member 12 during the extrusion process. The strips are positioned at intervals around the circumference of the tubular member 12.

The intermediate layer 16 may be a TPC, for example, similar to the reinforcing layer 14. In the first and second embodiments, the intermediate layer may include generally unidirectional fibers (e.g. fiberglass) within a thermoplastic.

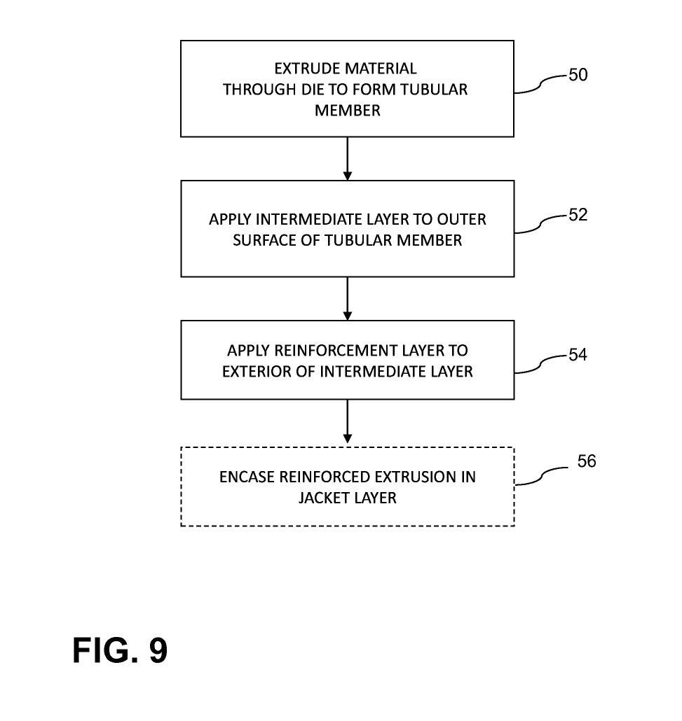

Referring now to the flow chart of FIG. 9, a first method for forming a reinforced pipe includes extruding a thermoplastic material into a tubular liner or preform at step 50. The liner preferably is circular in cross section. The material is HDPE in the present embodiment, but can include other suitable materials as desired.

At step 52, a longitudinal reinforcement layer is applied to the outer surface of the formed tubular member. As an alternative or a supplement, the reinforcement layer may be placed within the wall of the tubular member during the extrusion step 50. The longitudinal reinforcement layer may be a TPC tape applied in strips that are oriented parallel to a longitudinal axis of the preform. The strips may form a continuous circumferential layer that encircles the entire preform, or may be applied to include spacing or intervals between the strips, as described above.

A radial reinforcement layer is wrapped around the intermediate layer and tubular member at step 54. The two reinforcement layers may be made of substantially the same or similar materials. Optionally, the radial reinforcement layer may be made of a material that is different from the longitudinal reinforcement layer.

Finally, an optional jacket layer can be applied as an extrudate over the radial reinforcing layer at step 56. Heat may be applied to the reinforced pipe to thermally bond the layers together at any or multiple points during the described method.

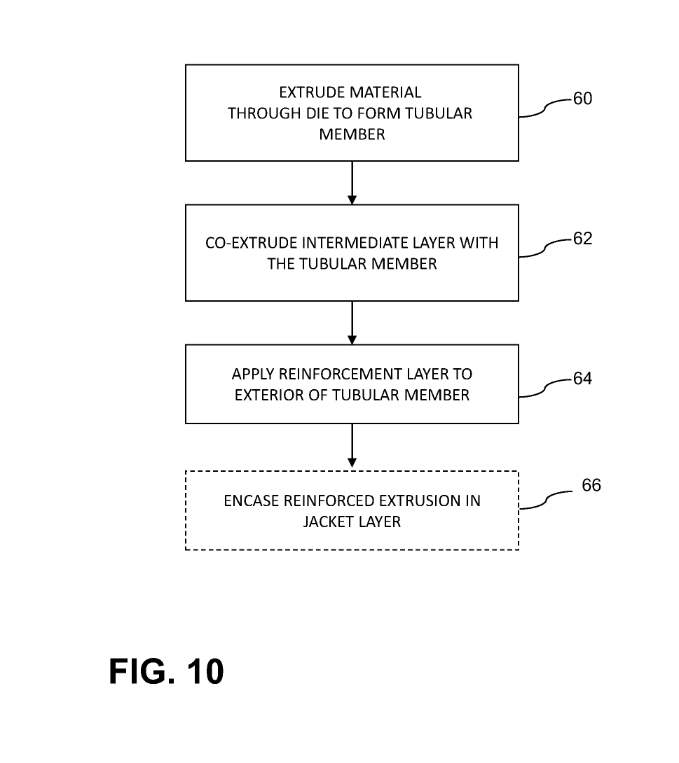

Referring now to the flow chart of FIG. 10, a second method for forming a reinforced pipe includes co-extruding at step 60 a polymeric material and a longitudinal reinforcing layer or material. The polymeric material of the current embodiment is HDPE, but the material can be or include other suitable materials as desired. The longitudinal reinforcing layer may include, for example, fibers, threads, rods, or strips that are oriented generally parallel to the longitudinal axis of the tubular member.

At step 64 a radial reinforcing layer is wrapped around the tubular member. The two reinforcing layers may be made of substantially the same or similar material to that of the tubular member. Optionally, the reinforcing layer may be made of a material that is different than that of the tubular member.

Further, once the reinforcing layer is applied, an optional jacket layer can be applied as an extrudate over the radial reinforcing layer at step 66. Heat may be applied to the reinforced pipe to thermally bond the layers together at any or multiple points during the described method.

Under high pressures, the tendency of the pipe is to expand radially. However, the radial reinforcing layer, which is within or on the liner, does not stretch, and therefore prevents the reinforced pipe from expanding circumferentially. The longitudinal reinforcement layer or material also does not stretch, and therefore prevents the pipe from expanding longitudinally or lengthwise. Therefore, the pipe is reinforced in both the radial and lengthwise directions, providing dimensional stability to the reinforced pipe even when subjected to high pressures.

The above descriptions are those of the current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. A reinforced pipe comprising:
a pipe preform having a longitudinal axis;
a radial reinforcing layer formed of helically wound material; and
a longitudinal reinforcing layer between the pipe preform and the radial reinforcing layer, wherein the intermediate layer is generally parallel to the longitudinal axis of the pipe preform.

2. The reinforced pipe of claim 1 wherein the pipe preform and the longitudinal reinforcing layer include at least one substantially similar material.

3. The reinforced pipe of claim 1 wherein the longitudinal reinforcing layer is thermally bonded to both the pipe preform and the radial reinforcing layer.

4. The reinforced pipe of claim 1 wherein the longitudinal reinforcing layer is continuous about the circumference of the pipe preform.

5. The reinforced pipe of claim 1 wherein the longitudinal reinforcing layer includes strips generally parallel to the longitudinal axis of the pipe preform and positioned at intervals around the circumference of the pipe preform.

6. The reinforced pipe of claim 1 further comprising a jacket disposed over the radial reinforcing layer.

7. A reinforced pipe comprising:
a liner having a longitudinal axis;
a radial reinforcement over the liner; and
a longitudinal reinforcement on or in the liner.

8. The reinforced pipe of claim 7 wherein the longitudinal reinforcement includes unidirectional fibers generally parallel to the longitudinal axis.

9. The reinforced pipe of claim 7 wherein the radial reinforcement includes helically wrapped unidirectional fibers.

10. The reinforced pipe of claim 7 wherein the longitudinal reinforcement and the radial reinforcement are substantially the same as or similar materials.

11. The reinforced pipe of claim 7 wherein the longitudinal reinforcement includes strips generally parallel to the longitudinal axis.

12. The reinforced pipe of claim 7 wherein the longitudinal reinforcement includes at least one of fibers, threads, and rods generally parallel to the longitudinal axis.

13. The reinforced pipe of claim 7 wherein the longitudinal reinforcement is thermally bonded to both the liner and the radial reinforcement.

14. The reinforced pipe of claim 7 further comprising a jacket over the radial reinforcement.

15. A method of making a reinforced pipe comprising:
providing a pipe liner having an axis;
applying a longitudinal reinforcing layer the pipe liner; and
applying a radial reinforcing layer over the longitudinal reinforcing layer.

16. The method according to claim 15 wherein the first applying step includes thermally bonding the longitudinal reinforcing layer to the pipe liner and to the radial reinforcing layer.

17. The method according to claim 15 wherein the longitudinal reinforcing layer includes unidirectional material generally parallel to the axis of the pipe liner.

18. A method of making a reinforced pipe comprising:
extruding a pipe preform including longitudinal reinforcement within the pipe preform, the pipe preform having an axis; and
helically wrapping a radial reinforcing layer over the pipe preform.

19. The method according to claim 18 wherein the longitudinal reinforcement includes unidirectional material generally parallel to the axis of the pipe preform.

20. The method according to claim 18 wherein the wrapping step includes thermally bonding the radial reinforcing layer to the pipe preform.
